(19) United States
(12) Patent Application Publication
(10) Pub. No.: US 2024/0032711 A1
(43) Pub. Date: Feb. 1, 2024

(54) SMART MIRROR

(71) Applicant: NEURONBASIC TECHNOLOGY INC., Santa Clara, CA (US)

(72) Inventor: RAYMOND WU, SANTA CLARA (US)

(21) Appl. No.: 17/825,452

(22) Filed: May 26, 2022

(51) Int. Cl. A47G 1/02; G06V 40/16

(52) U.S. Cl. CPC A47G 1/02; G06V 40/172

(57) ABSTRACT

The present invention provides a smart mirror, which can be installed in a bathroom vanity box, an indoor vanity table, or a general cosmetic mirror, sports mirror, etc., which is characterized in that an intelligent identification device is arranged inside the mirror. The main body of the intelligent recognition device is a controller, including at least combined with an image recognition device, and/or an infrared sensor, and/or a voice recognition device, and connected to a switch device with electrical wires. The switch device can be electrically connected to a defogging device, and/or an audio device, and/or a lighting device, and/or a playback device, respectively. In use, the external signal source is sensed by one or more identification components inside the controller. After accurately judging the input signal, one or several instructions will be sent to activate the corresponding one or more devices to perform predetermined functional actions. That achieves intelligent home use for human.

### FIELD OF THE INVENTION

The present invention relates to a smart mirror, which is characterized in that an intelligent identification device is arranged inside the mirror, and one or more sensors are used to make comprehensive judgments, to generate corresponding function presentations.

### BACKGROUND

Conventional cosmetic mirrors usually only have a single function of a mirror, providing users to watch their own images to organize their appearance. Another known smart makeup mirror box structure, namely Taiwan Patent No. M600422, utilizes an image recognition smart single chip to perform simple recognition and control functions. However, under the influence of the environment, such as when the light is not enough and the mirror surface is full of water vapor, the recognition effect is not good, so there is still needed to be improved.

### SUMMARY

The present invention provides a smart mirror, which can be installed in a bathroom vanity box, an indoor vanity table, or a general cosmetic mirror, sports mirror, etc., which is characterized in that an intelligent identification device is arranged inside the mirror. The main body of the intelligent recognition device is a controller, including at least combined with an image recognition device, and/or an infrared sensor, and/or a voice recognition device, and connected to a switch device with electrical wires. The switch device can be electrically connected to a defogging device, and/or an audio device, and/or a lighting device, and/or a playback device, respectively. In use, the external signal source is sensed by one or more identification components inside the controller. After accurately judging the input signal, one or several instructions will be sent to activate the corresponding one or more devices to perform predetermined functional actions. That achieves intelligent home use for human.

### BRIEF DESCRIPTION OF THE DRAWING

FIG. 1 is a schematic diagram of the present invention.

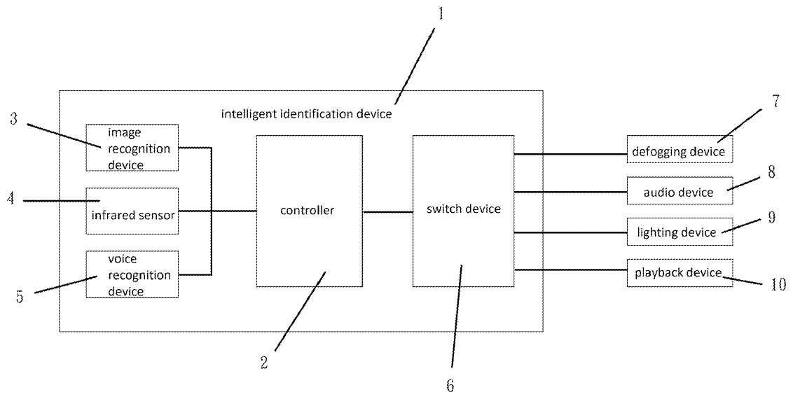

### DETAILED DESCRIPTION AND PREFERRED EMBODIMENT

The present invention relates to a smart mirror, which is characterized in that an intelligent identification device 1 is arranged inside the mirror. The main body of the intelligent recognition device 1 is a controller 2, and including at least combined with an image recognition device 3, and/or an infrared sensor 4, and/or a voice recognition device 5, and connected to a switch device 6 with electrical wires. The switch device 6 can be electrically connected to a defogging device 7, and/or an audio device 8, and/or a lighting device 9, and/or a playback device 10, respectively.

When in use, the smart mirror of this invention can be installed in the vanity box in the bathroom, or on the indoor vanity table, or as a general cosmetic mirror, sports mirror, etc., providing a variety of smart home life functions. It is to be understood that the controller 2 of the intelligent identification device 1 can achieve the convenient effects of identification, judgment, and action, including to use the image recognition device 3 sending a command to the switch device 6 when a preset specific image or gesture is detected, or to use the infrared sensor 4 to provide an auxiliary identification function in a low-light environment, or to use the voice recognition device 5, which provides the user with the ability to send commands from anywhere. Hence, this can provide the switch device 6 to activate the defogging device 7 to remove the fog or water vapor on the mirror surface, and/or the audio device 8 to play selected music, and/or the lighting device 8 to change the brightness of the light, And/or a playback device 10 that converts the mirror into a screen to project a specific image.

The intelligent identification device 1 of this invention is a single structure and does not need to be connected to the cloud or external nets. The detected images will be deleted immediately after interpretation, so no large-capacity memory is required, and the problem of privacy leakage can be avoided. Each detection device can be operated independently or at the same time, which can effectively improve the recognition efficiency. And after the identification of the invention, through the switch device, one or more mechanisms can be activated at the same time to obtain the effect of multiple functions. It is practical and progressive.

In application, under the framework of this invention, different identification devices can be combined to improve the identification performance or combined with other action mechanisms to provide greater satisfaction in smart home life. It is known that any additions or modifications made under the spirit of this invention are still included in the scope of this patent.

I claim:

1. A smart mirror, which can be installed in a bathroom vanity box, an indoor vanity table, or a general cosmetic mirror, sports mirror, etc., which is characterized in that an intelligent identification device is arranged inside the mirror, wherein a main body of the intelligent recognition device is a controller, and including
at least combined with an image recognition device, and/or an infrared sensor, and/or a voice recognition device, and all connected to a switch device with electrical wires, and
the switch device being electrically connected to a defogging device, and/or an audio device, and/or a lighting device, and/or a playback device, respectively.

2. The smart mirror as claimed in claim 1, wherein the image recognizer, the infrared sensor, and the voice recognizer can operate independently or simultaneously, used to detect and determine the source of the signal, and then send the result to the controller.

3. The smart mirror as claimed in claim 1, wherein the switch device can issue one or more commands to activate the defogging device, and/or the audio device, and/or the lighting device, and/or the playback device.
